(19) United States
(12) Patent Application Publication
(10) Pub. No.: US 2004/0124259 A1
(43) Pub. Date: Jul. 1, 2004

(54) Liquid atomization system for automotive applications

(75) Inventors: Yann Guezennec, Upper Arlington, OH (US); Shawn Midlam Mohler, Columbus, OH (US)

Correspondence Address: STANDLEY LAW GROUP LLP, 495 METRO PLACE SOUTH, SUITE 210, DUBLIN, OH, 43017, US

(73) Assignee: The Ohio State University, Columbus, OH

(21) Appl. No.: 10/662,983

(22) Filed: Sep. 15, 2003

Related U.S. Application Data
(60) Provisional application No. 60/410,428, filed on Sep. 13, 2002.

(51) Int. Cl. B05C 1/00

(52) U.S. Cl. 239/135

(57) ABSTRACT

The present invention provides a system comprising an atomizer for producing a mist of sub-micron sized fluid droplets. Also provided by the present invention are fluid delivery systems, a system for treating an exhaust stream by injecting an atomized spray, a catalytic system for treating at least one chemical species, and a system for humidifying an air stream for use in fuel cell.

This application claims the benefit of U.S. Provisional Application Serial No. 60/410,428, filed Sep. 13, 2002, which is hereby incorporated herein by reference.

### TECHNICAL FIELD OF THE INVENTION

The present invention involves various applications for atomizing system capable of producing an aerosol of sub-micron sized liquid particles. The invention involves the use of this atomizing system technology in specific modes of operation and applications relevant to the automotive field.

### BACKGROUND OF THE INVENTION

It has long been recognized that a finely atomized spray of small fluid droplets can be formed when a liquid under pressure is released into the ambient air if the liquid being released is at a temperature such that the vapor pressure of the liquid is greater than the ambient pressure. This principle is extensively used for aerosol sprays, in which the propellant gas (usually propane or butane) is maintained at ambient temperature at a pressure such that the propellant is in a liquid state. Upon release through an orifice or nozzle to the ambient pressure (less than the vapor pressure at that temperature), the liquid is immediately evaporated. This mechanism does not work for liquid where the vapor pressure at ambient pressure is significantly less than ambient. U.S. Pat. No. 3,731,876 by M. R. Showalter in 1973 describes clearly that by providing both pressurization and heating of the liquid upstream of a nozzle can lead to an excellent level of atomization of a liquid upon exiting the orifice or nozzle. That patent specifically states that the mechanism for atomization is valid for liquid in a sub-critical state. More recent patents by Hunt and Hunt et al. describe a related mode of atomization where a liquid is pressurized to high pressures and heated with a tube arrangement so that the liquid is brought past or near the critical point. A related recent patent by Oljaca et al. (U.S. Pat. No. 6,601,776 B1) eliminates the need for high pressures past or close to the liquid critical point and requires that the liquid undergoes partial boiling in the tube or chamber. These patents address in broad terms the need to control the temperature of the tube or chamber to control the degree of atomization at the exit of the tube or chamber, and further specify that the exit of the tube or chamber must be unobstructed.

For a very broad range of automotive applications requiring liquid atomization, including—but not restricted to, fuel or water delivery to internal combustion engine intakes, internal combustion engine combustion chambers, internal combustion engine exhaust streams, exhaust after-treatment systems, fuel reformers for engines and fuel cell systems, compressors/turbo-chargers/super-chargers for internal combustion engines and fuel cell systems), the following attributes must simultaneously be met for a device or process to be of practical relevance: the device or process must be capable of finely controlling the fluid flow rate over a broad turn down ratio between a minimum flow rate (typically zero) and a maximum; the device or process must be capable of preserving the quality of the atomization (mean droplet size, droplet size distribution) over the entire range of flow rates; the device or process must be capable of dynamically changing the fluid flow rate and have a dynamic response commensurate with the load changes experienced in automotive applications; the device must be rugged in its embodiment to sustain the harsh automotive environments (wide ambient temperature range, high vibration environment); the device or process must be easily controllable and capable of being easily interfaced to conventional automotive controllers; and finally, the device or process cannot change or significantly alter the chemical composition of the liquid being atomized. Previous patents of related devices or processes fail to address these multiple automotive requirements.

The system (device and process) described here consists of an atomizer device, a flow control element, a feedback element capable of directly correlating with the atomization quality (typically, but not restricted to, one or more temperature feedback sensors), and a controller capable of dynamically adjusting the flow rate over a wide range while maintaining or controlling the atomization level simultaneously, and conditions at the outlet of the device in the various applications such that the atomization phenomena is stable and leads to finely dispersed aerosols.

In view of the present disclosure or through practice of the present invention, other advantages may become apparent.

### SUMMARY OF THE INVENTION

In general terms, the present invention includes a first system for producing a mist of sub-micron sized fluid droplets. The system comprises: (1) an atomizer comprising: (a) a fluid conduit for transporting a pressurized supply of a fluid, the fluid conduit having an inlet and an outlet, wherein the outlet discharges the fluid into a discharge zone; and (b) a heating element in thermal contact with the fluid conduit such that the heating element delivers sufficient thermal energy to the fluid traversing the fluid conduit such that the vapor pressure of the fluid is greater than the pressure in the discharge zone so as to cause the fluid to atomize in the discharge zone thereby producing a mist of sub-micron sized fluid droplets; (2) a temperature sensor, the temperature sensor in thermal contact with the fluid so as to determine the temperature of the fluid; (3) a flow control element in fluid communication with the atomizer, the flow control element controlling the volumetric flow rate of the fluid; and (4) a controller, the controller in electrical communication with the temperature sensor, the flow control element, and the heating element, the controller capable of adjusting the heating element's delivery of thermal energy to the fluid in response to the temperature of the fluid and the volumetric flow rate of the fluid, the controller capable of causing the flow control element to adjust the volumetric flow rate of the fluid.

It is preferred that the heating element is a glow plug. It is equally preferred that the heating element is an external heat source.

It is preferred that the fluid conduit is capillary tubing. It is even more preferred that the capillary tubing comprises two electrical contacts for applying a current thereto for resistively heating the capillary tubing.

A second system for producing a mist of sub-micron sized fluid droplets, said system comprising: (1) an atomizer, the atomizer comprising: (a) a fluid conduit for transporting a pressurized supply of a fluid, the fluid conduit having an inlet and an outlet, wherein the outlet discharges the fluid into a discharge zone, the fluid conduit additionally comprising at least two electrical contacts for applying a current across the fluid conduit so as to resistively heat the fluid conduit such that the vapor pressure of the fluid is greater than the pressure in the discharge zone so as to cause the fluid to atomize in the discharge zone thereby producing a mist of sub-micron sized fluid droplets; (2) a temperature sensor, the temperature sensor in thermal contact with the fluid so as to determine the temperature of the fluid; (3) a flow control element in fluid communication with the atomizer, the flow control element controlling the volumetric flow rate of the fluid; and (4) a controller, the controller in electrical communication with the temperature sensor, the flow control element, and the heating element, the controller capable of adjusting the heating element's delivery of thermal energy to the fluid in response to the temperature of the fluid and the volumetric flow rate of the fluid, the controller capable of causing the flow control element to adjust the volumetric flow rate of the fluid.

Although the applications discussed below are presented from the standpoint of the first system for producing a mist of sub-micron sized fluid droplets, the second system discussed above is equally functional and may be substituted for the first system in each instance.

For certain applications it is desirable to have a more compact atomizer, in these instances it is preferred that the fluid conduit is a coiled tube. It is also preferred that the fluid conduit comprises two electrical contacts for applying a current thereto for resistively heating the fluid conduit.

It is additionally preferred that the temperature sensor measures the temperature of the fluid at said outlet. It is equally preferred that the temperature sensor measures the temperature of the fluid conduit. It is also preferred that the electrical resistance of the fluid conduit is used to determine the temperature of the fluid conduit.

The present invention additionally comprises engines, vehicles, fuel reformers, and air delivery systems of a fuel cell system comprising the above-described system.

The present invention further comprises a fluid delivery system comprising: (1) a pressurized supply of a fluid, wherein the inlet pressure of said fluid is higher than the discharge pressure of the fluid; (2) a flow control device in fluid communication with the pressurized supply of a fluid, the flow control device actuating in response to a signal so as to open the flow control device thereby permitting the fluid through the flow control device; (3) an atomizer, the atomizer in fluid communication with the flow control device so as to receive the fluid from the flow control device at a desired volumetric flow rate, the atomizer comprising: (a) a fluid conduit for transporting a pressurized supply of a fluid, the fluid conduit having an inlet and an outlet, wherein the outlet discharges the fluid into a discharge zone; and (b) a heating element in thermal contact with the fluid conduit such that the heating element delivers sufficient thermal energy to the fluid traversing the fluid conduit such that the vapor pressure of the fluid is greater than the pressure in the discharge zone so as to cause the fluid to atomize in the discharge zone thereby producing a mist of sub-micron sized fluid droplets; (4) a temperature sensor, the temperature sensor in thermal contact with the fluid so as to determine the temperature of the fluid; and (5) a controller, the controller in electrical communication with the temperature sensor and the heating element, the controller capable of adjusting the heating element's delivery of thermal energy to the fluid in response to the temperature of the fluid and the desired volumetric flow rate.

It is preferred that the pressurized supply of a fluid has a pressure higher than the discharge pressure of the fluid conduit.

Although any type of signal may be used, it is preferred that the signal is pulse width modulated signal or analog signal.

Although any type of flow control device may be used, it is preferred that the flow control device is a fast acting solenoid valve, a servo-valve, or an electrically controllable flow restriction.

Although the flow control device may be placed anywhere (including downstream) relative to the fluid conduit, it is preferred that the flow control device is positioned upstream of the fluid conduit. It is also preferred that the flow control device is placed within the fluid conduit.

The present invention further comprises engines, vehicles, and fuel reformers comprising the fluid delivery system described above.

The present invention additionally comprises a system for treating an exhaust stream by injecting an atomized spray comprising: (1) an exhaust stream, the exhaust stream comprising at least one chemical species to be treated, the at least one chemical species having an initial concentration; (2) a flow control device in fluid communication with a pressurized supply of a fluid, the fluid control device actuating in response to a signal so as to open the flow control device thereby permitting the fluid through the flow control device; (3) an atomizer, the atomizer in fluid communication with the flow control device so as to receive the fluid from the flow control device at a desired volumetric flow rate, the atomizer comprising: (a) a fluid conduit for transporting a pressurized supply of a fluid, the fluid conduit having an inlet and an outlet, wherein the outlet discharges the fluid into the exhaust stream; and (b) a heating element in thermal contact with the fluid conduit such that the heating element delivers sufficient thermal energy to the fluid traversing the fluid conduit such that the vapor pressure of the fluid is greater than the pressure in the exhaust stream so as to cause the fluid to atomize in the exhaust stream thereby producing a mist of sub-micron sized fluid droplets; (4) a temperature sensor, the temperature sensor in thermal contact with the fluid so as to determine the temperature of the fluid; (5) a controller, the controller in electrical communication with the temperature sensor and the heating element, the controller capable of adjusting the heating element's delivery of thermal energy to the fluid in response to the temperature of the fluid and the desired volumetric flow rate; and (6) a catalyst, the catalyst chemically interacting with the at least one chemical species so as to treat the at least one chemical species thereby diminishing the initial concentration of the at least one chemical species.

The present invention additionally comprises a catalytic system for treating at least one chemical species comprising: (1) an exhaust stream comprising at least one chemical species, the exhaust stream directed towards a catalyst; a catalyst for chemically treating the at least one chemical species; (2) a flow control device in fluid communication with a pressurized supply of a fluid, the flow control device actuating in response to a signal so as to open the flow control device thereby permitting the fluid through the flow control device; (3) an atomizer, the atomizer in fluid communication with the flow control device so as to receive the fluid from the flow control device at a desired volumetric flow rate, the atomizer comprising: (a) a fluid conduit for transporting a pressurized supply of a fluid, the fluid conduit having an inlet and an outlet, wherein the outlet discharges the fluid into the exhaust stream; and (b) a heating element in thermal contact with the fluid conduit such that the heating element delivers sufficient thermal energy to the fluid traversing the fluid conduit such that the vapor pressure of the fluid is greater than the pressure in the exhaust stream so as to cause the fluid to atomize in the exhaust stream thereby producing a mist of sub-micron sized fluid droplets; (4) a temperature sensor in thermal contact with the fluid so as to determine the temperature of the fluid; and (5) a controller in electrical communication with the temperature sensor and the heating element, the controller capable of adjusting the heating element's delivery of thermal energy to the fluid in response to the temperature of the fluid and the desired volumetric flow rate.

It is preferred that the catalytic system additionally comprises at least one non-thermal plasma generator disposed upstream of the catalyst and downstream of the atomizer.

It is also preferred that the catalytic system additionally comprises at least one secondary catalyst upstream of the catalyst, the at least one secondary catalyst selected from the group consisting of: low thermal inertia catalysts and electrically heated catalysts, the secondary catalyst capable of producing heat from a chemical reaction when the atomizer introduces the mist of sub-micron sized fluid droplets into the exhaust stream, the heat subsequently acting to raise the temperature of the catalyst downstream.

It is further preferred that the fluid is an aqueous urea solution and that the catalyst is a SCR catalyst.

The present invention further comprises a system for humidifying an air stream for use in a fuel cell comprising: (1) an air stream; (2) a flow control device in fluid communication with a pressurized supply of a fluid, the flow control device actuating in response to a signal so as to open the flow control device thereby permitting the fluid through the flow control device; (3) an atomizer, the atomizer in fluid communication with the flow control device so as to receive the fluid from the flow control device at a desired volumetric flow rate, the atomizer comprising: (a) a fluid conduit for transporting a pressurized supply of a fluid, the fluid conduit having an inlet and an outlet, wherein the outlet discharges the fluid into the air stream; and (b) a heating element in thermal contact with the fluid conduit such that the heating element delivers sufficient thermal energy to the fluid traversing the fluid conduit such that the vapor pressure of the fluid is greater than the pressure in the air stream so as to cause the fluid to atomize in the air stream thereby producing a mist of sub-micron sized fluid droplets; (4) a temperature sensor, the temperature sensor in thermal contact with the fluid so as to determine the temperature of the fluid; (5) a controller, the controller in electrical communication with the temperature sensor and the heating element, the controller capable of adjusting the heating element's delivery of thermal energy to the fluid in response to the temperature of the fluid and the desired volumetric flow rate; and (6) a compressor in fluid communication with the air stream, the compressor pressurizing the air stream so as to generate a pressurized flow of air; and a fuel cell in fluid communication with the compressor, the fuel cell receiving a pressurized flow of air from the compressor.

Although the atomizer may introduce the mist of sub-micron sized fluid droplets anywhere in the system, it is preferred that the mist of sub-micron sized fluid droplets are introduced either upstream of the compressor or within the compressor.

### BRIEF DESCRIPTION OF THE DRAWINGS

FIG. 1 illustrates one embodiment of the present invention based on a glow-plug style heating element.

FIG. 2 illustrates a second embodiment of the present invention based upon a hypodermic tube.

FIG. 3 illustrates a variation on the second embodiment of the present invention wherein the hypodermic tube is coiled.

FIG. 4 is a photograph of a coiled hypodermic tube-style atomizer that has been additionally provided with external packaging.

FIG. 5 is a photograph of a multiple glow plug-style atomizer that has been additionally provided with external packaging.

FIG. 6 is a schematic of the fuel delivery system for the present invention.

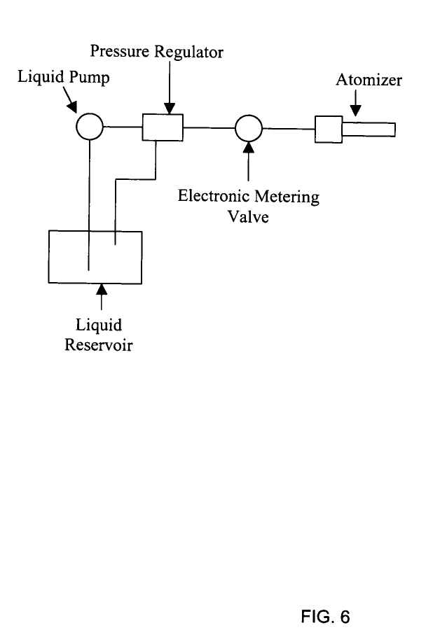

FIG. 7 is a schematic of the atomizer control system used in the present invention.

FIG. 8 is a photograph of atomized No. 2 diesel fuel in a flask at ambient conditions immediately following atomization.

FIG. 9 is a photograph of the atomized No. 2 diesel fuel flask at ambient conditions two minutes after atomization.

FIG. 10 is a schematic of one embodiment of a lean NOₓ catalyst system of the present invention.

FIG. 11 is a schematic of one embodiment of a non-thermal plasma system of the present invention.

FIG. 12 is a schematic of one embodiment of a lean NOₓ trap system of the present invention.

FIG. 13 is a schematic of one embodiment of a urea-SCR system of the present invention.

FIG. 14 is a schematic of one embodiment of a particulate trap system of the present invention.

FIG. 15 is a schematic of one embodiment of a rapid light-off system of the present invention.

FIG. 16 is a schematic of one embodiment of a fuel reformer application for an aftertreatment system of the present invention.

FIG. 17 is a schematic of one embodiment of a rich combustor system for reductant formation of the present invention.

FIG. 18 is a schematic of one embodiment for a water injection system for fuel cell systems of the present invention.

### DESCRIPTION OF THE PRINCIPLE OF OPERATION OF THE PREFERRED EMBODIMENT(S)

With this atomizing system, it is believed that the liquid to be atomized is mildly pressurized (0-30 psig, typically) to control its flow through an elongated orifice (tube),

With this atomizing system, it is believed that heating is applied to the liquid flowing through the tube by either external means or electrical ohmic heating,

With this atomizing system, it is believed that some of the heat to be supplied can be provided to the liquid upstream of the device in such manner that the liquid does not undergo vaporization through this pre-heating phase,

With this atomizing system, it is believed that the high aspect ratio (50:1 or more, typically) of the tube provides a very high surface to volume ratio which provides a very effective mean of heat transfer between the fluid to be atomized and the heat source,

With this atomizing system, it is believed that, the liquid in the tube is brought to a state where it is either vaporized or consists of a mixture of vapor and liquid at a controlled temperature,

With this atomizing system, it is believed that the temperature and pressure in the liquid in the tube must be controlled in such a way that the fluid is either vaporized in the tube or such that the vapor pressure of fluid at that temperature is greater or equal to the pressure in which the fluid is discharged at the exit of the tube,

With this atomizing system, it is believed that the vapor either formed in the tube or by flash boiling at the exit of the tube undergoes a very rapid expansion at high speed in the form of an expanding, highly turbulent jet into the gas in which it discharges,

With this atomizing system, it is believed that this rapid, turbulent expansion of the vapor phase contributes to a very significant mixing and dispersion into the gas in which the tube discharges,

With this atomizing system, it is believed that the temperature of the gas in which the tube discharges is such that the vapor pressure of the liquid at that temperature is significantly less than the pressure of the gas in which it discharges, hence leading to re-condensation of the dispersed vapor phase at very many nucleation sites to form sub-micron droplets,

With this atomizing system, it is believed that there must be enough entrainment of the aerosol of droplets by the ambient gas in which it forms, so that the temperature conditions at the exit and in the droplet formation zone downstream remain unaffected for the phenomena of droplet condition to continue (no heat build-up in confined spaces with no or little ambient gas flow),

With this atomizing system, it is believed that the temperature of the liquid (or the tube in which it flows), the physical properties of the liquid, as well as the exit pressure, and temperature conditions all control the phenomena of droplet formation,

With this atomizing system, it is believed that for a given liquid and exit conditions, the temperature of the liquid (or the tube in which it flows) controls the occurrence of the droplet formation, and that the size of the droplets is directly controlled by this temperature and the conditions in which they form,

With this atomizing system, it is believed that the surface tension characteristics of the very small droplets formed in this manner make it very difficult for the droplets to coalesce into bigger droplets,

With this atomizing system, it is believed that the very small droplets have very little inertia and gravity forces compared to their aerodynamic drag, hence making them prone to follow the ambient fluid flow and mix with little or no gravitational settling,

With this atomizing system, it is believed that the very small droplets have very little inertia and gravity forces compared to their aerodynamic drag, hence making them lose their high speed quickly downstream of the nozzle and hence their ability to impact or target nearby surfaces (as a larger droplet would, leading to liquid film formation or wall wetting on cold surfaces),

With this atomizing system, it is believed that the small droplets form a very homogeneous stable aerosol in suspension in the ambient gas,

With this atomizing system, it is believed that the very high surface to volume ratio of the droplets makes them very suitable to very rapid re-evaporation if the gas/droplet mixture is subjected to temperature rises downstream of the droplet formation region.

### DETAILED DESCRIPTION OF THE PREFERRED EMBODIMENT(S)

In accordance with the foregoing summary of the invention, the following presents a detailed description of the preferred embodiment of the invention that is presently considered to be its best mode. We begin by presenting the several atomizers suitable for use in practicing the present invention before discussing the actual invention.

### The Glow-Plug Style Atomizer

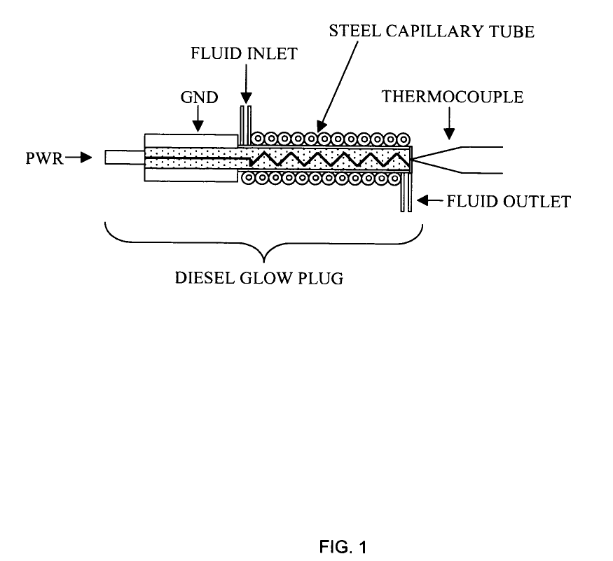

FIG. 1 illustrates one practical physical embodiment of the atomizer for automotive applications. For ruggedness and compatibility with existing automotive technology, the device is constructed using a diesel glow plug as the foundation. A length of steel capillary tubing is attached to the glow plug providing a thermal contact of the tube to the glow plug sheath. The method of attachment can be brazing, welding, or any other suitably temperature resistant method. By tube, we refer to an elongated flow passage (not necessarily circular in cross-section) where the length-to-diameter ratio (aspect ratio) is at least 10.

A standard glow plug consists of a positive end terminal which leads to a heating element inside the glow plug sheath. The heating element is typically encased in a ceramic insulator to prevent shorting to the grounded steel sheath. When power is applied to the device, the surface of the sheath rapidly warms due to the heat generated by the heating element within. The power supply in current automotive applications is typically 12 or 24 VDC; however, the device is not restricted to this voltage level.

When the liquid to be atomized is fed through the capillary tube via the fluid inlet, it is heated by the glow plug. As described above, this heating process, along with the physical geometry and its mode of control can be used to atomize the liquid when it is released from the fluid outlet. In the embodiment described here, the position of the fluid inlet and outlet are reversible.

Proper control of this device/process with respect to the atomization quality uses a thermocouple that is attached to the glow plug, or to the capillary tube as a temperature feedback element. This thermocouple provides temperature feedback that allows a controller to modulate the power input to insure proper atomization. Alternatively, similar small temperature measurement sensors can be used, such as RTD sensors). This feedback is also crucial in preventing the device from overheating and allows the device to compensate for variable fluid inlet temperatures, varying ambient conditions, and varying fluid flow rates. Alternatively, temperature regulation can be achieved passively with no external sensor by using internally temperature-regulated heating elements such as temperature-regulated glow plugs.

The figure shown above does not include external packaging. Packaging of the device into a rugged package with all proper connections is a trivial matter to one skilled in the art. This version of the atomizer has a relatively large thermal mass and thus requires roughly one to a few seconds to initially warm up before fuel can be atomized.

Depending on the range of required flow rates of fluid, the tube diameter can be varied to match the available pressure difference between the feed pressure to the device and the discharge pressure of the device to the flow rate requirements. Maximum flow rates ranging from a small fraction of 1 mL/min to 100 mL/min are achievable with a single tube depending on tube diameter and pressure difference between the device inlet and outlet.

For higher flow rate requirements not practically achievable with one tube, the device is inherently scalable by having multiple tubes in parallel. In such arrangements, heating can be common to all tubes or separate heating elements and temperature feedback can be used.

### The Resistive Heating Tube Atomizer

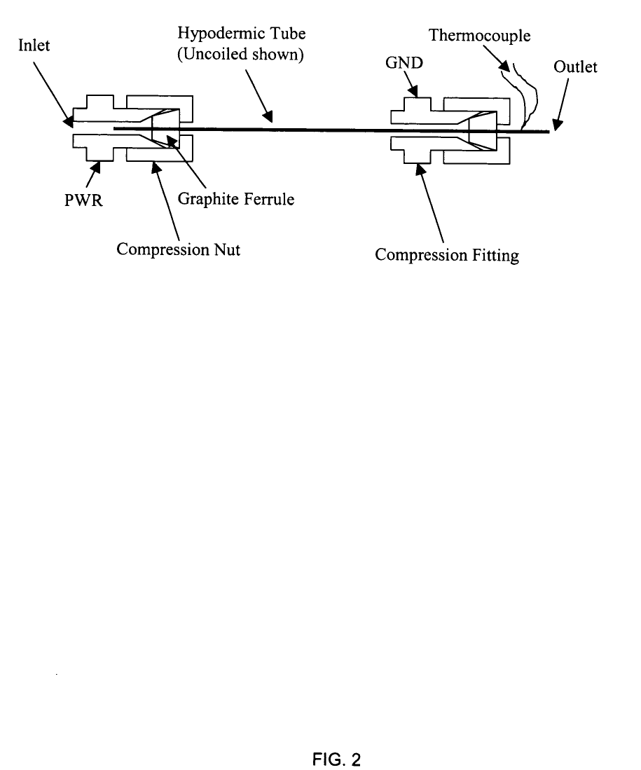

A second embodiment of the atomization device utilizes the actual fluid conduit carrying the fluid as a heating element, as shown in FIG. 2. A thin walled, stainless steel tube, commonly referred as “hypodermic tubing” has a resistance of less than a few ohms typically for a length of a few inches. This allows the tube itself to be effectively used as the resistive element in a resistive heating system. As current is passed through the tube, it heats the fluid within the tube, providing a very effective distributed heating element with high surface to volume ratio and low thermal inertia. As described above, heating the pressurized liquid can lead to atomization of the fluid downstream of the outlet of the tube if the temperature of the fluid is sufficient.

By tube, we refer to an elongated flow passage (not necessarily circular in cross-section) where the length-to-diameter ratio (aspect ratio) is at least 10.

Stainless-steel, while one of the most common materials for a practical embodiment, is not required. Any material having the mechanical strength and the required electrical resistivity and which can be engineered into a small diameter tube is adequate.

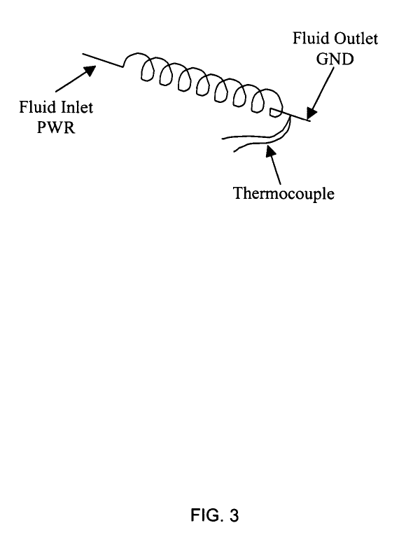

A coiled tube configuration, where electrical connections are provided at both ends for the current required for heating the tube (depicted in FIG. 3) is preferred for the resistive heating tube embodiment. The coiled tube makes the device more compact, and the coiled arrangement allows for thermal expansion while remaining hydraulically, mechanically and electrically connected.

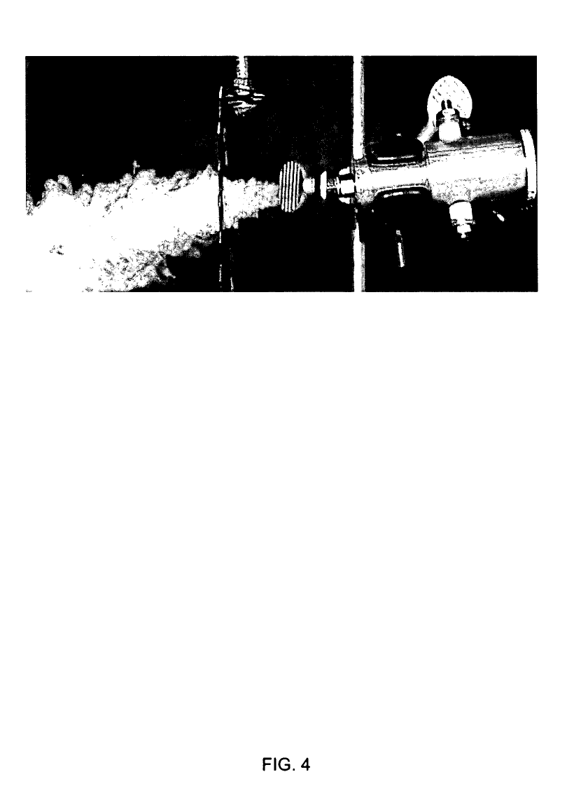

FIG. 4 is a photograph of a coiled tube atomizer protected by an outer shell casing. The hypodermic tube can be secured at both ends using a conductive graphite ferrule with a compression fitting, providing a mechanical support inside the outer casing, as well as a proper fluidic connection to the supply tube upstream and an electrically conducting, low resistance connection at both ends to provide a path for the electrical current. More importantly, it allows the tube to act as a spring to deflect in the axial direction as the tube expands and contracts due to heating and cooling. A straight tube with fixed ends undergoes deflection which can lead to failure over several heating and cooling cycles. Finally, the outer casing serves as a mechanical protection, an electrical ground path for the current, a thermal insulation to minimize heat loss and a practical way to mount the device. In the implementation shown in FIG. 4, the device is packaged in a volume and length approximately equivalent to that of a conventional gasoline fuel injector.

FIG. 4 shows one version of the packaging of the coiled tube atomizer. The power and ground terminals are shown, as well as the fluid inlet and outlet. The packaging represents only one potential configuration of the device. The temperature sensor connection is not visible in the photo, but it exits the body of the atomizer on the side not shown in the photo.

Proper control of this version of the atomizer is considerably more difficult automotive applications than the glow plug-style atomizer, (see later section on control). Due to the low thermal mass of the hypodermic tube, overheating can easily result causing the tube to melt and subsequently rupture. Overheating can occur in small fraction of a second. However, the low thermal mass of the device has the advantage of being able to rapidly respond to transient liquid flows as well as giving near instantaneous start-up capability.

Similar to a conventional fuel injector, one feature of both atomizing devices discussed above is the absolute necessity to have a relatively open space downstream of the outlet of the atomizer and/or good entrainment of the finely atomized liquid by a gas stream (air, exhaust, etc.). Very confined conditions downstream of the outlet lead to the rapid condensation of the liquid droplets on the walls of the confined space, unless significant entrainment of the atomized liquid is performed by a moving gas. Only the discharge of the atomizer into either flowing gasses in relatively confined spaces (such as, but not restricted to, intake passages, compressors and similar devices, combustion chambers or reaction chambers, exhaust manifolds or systems) or unconfined quiescent or near quiescent conditions (such as, but not restricted to, ambient room conditions, etc.) allow for proper atomization to occur. In unconfined applications, the space in which the atomizer discharges must be sufficiently open that significant self-entrainment of the ambient gas by the discharge of the atomizer at high speeds avoids any significant heat build-up in the discharge region immediately downstream of the atomizer where nucleation and fine droplet formation occurs.

Preheating of the fuel before it enters the atomizer can significantly reduce power consumption of the device. This also allows for increasing the flow through a device significantly. Preliminary testing has confirmed that power consumption can be reduced by over half through this method. The manner of preheating the fluid can be from any source, including but not limited to: electrical heating, flame heating, and waste heat recovery, such as (but not limited to) engine coolant, engine or transmission oil, exhaust gases, or turbo- or supercharger exit stream. The control system enables the device to adjust to any level of fluid preheating. The ability to preheat the liquid also allows for a cascaded system in which a glow plug (or external source) provides preheating to the fluid, and then a resistively heated tube atomizer atomizes the fuel completely. This gives the advantage of the fast response of the heated tube atomizer.

One possible cascaded system specifically for fuel applications requiring a high flow rate device with minimal electrical consumption is to use a miniature atomizer to atomize a small quantity of fuel and subsequently combust it (flame based combustion or catalytic combustion). The heat generated from this combustion process is then used to preheat the bulk of the fuel to be atomized by the main system. This preheated fuel can then be delivered to any number of atomizers which simply finish the heating process using minimal electrical energy. Using the preheated fuel, a low electrical power atomizer can atomize a very large amount of fuel with a leveraging effect of more than 10:1 in terms of the amount of electrical energy being used. This method would allow for flow rates high enough to power a large combustion engine or generate a significant amount of thermal energy through combustion.

### The Fluid Delivery System

As stated before, in automotive applications, the fluid delivery system must (in a stand alone configuration or in combination with the atomizer device) be capable of varying and controlling the fluid flow rate over a wide range (typically from zero to a maximum). In all fluidic systems, the flow rate is directly governed by the pressure differential applied between the fluid inlet and fluid outlet and/or the flow resistance within the device, where the flow resistance is directly dependent on the geometry of the fluid passage. Hence, flow control can be achieved by varying the pressure differential across the device at fluid passage geometry, or by varying the fluid path geometry at fixed pressure differential across the device, or both. This varying of the fluid path geometry and hence fluid resistance, can occur upstream, downstream, or within the atomizer using external or imbedded variable geometry elements, such as, but not restricted to, poppet or needle valves, pintles, piezo- or magneto-deformable elements, etc.

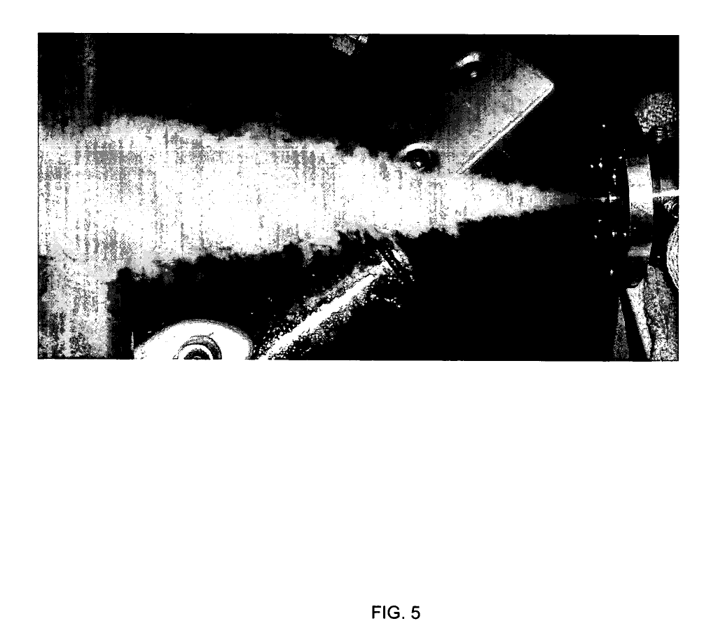

FIG. 5 illustrates one simple embodiment of a liquid delivery system for the atomizer building upon a commonly used architecture for liquid delivery system in automotive applications. Liquid for the liquid reservoir is pressurized by the low-pressure liquid pump. A standard automotive style fuel pump is used in this application, but any suitable pump can be used. A pressure regulator maintains a constant pressure upstream of the electronic metering valve. This pressure is typically within the range of 1-100 psi, (most typically 15-25 psi) above the pressure of the gas in which the atomizer discharges.

The electronic metering valve is a fast acting solenoid valve, commonly used in process control or derived from an automotive-style port fuel injector. With this type of metering valve, a pulse width modulated signal is sent to the valve that controls the duty cycle of its opening and closing. This dictates the amount of fuel delivered to the atomizer. This type of control is common in the automotive or process industry, and is how many flow control devices (such as fuel injectors, EGR valves, etc.) are driven in automotive applications.

It is sometimes necessary or desirable to include a small compliance element (such as, but not restricted to, small fluid accumulator, deformable feed tube or pipe, etc.) between the metering valve and the atomizer. This may be necessary to smooth out the rapid pulsations from the metering valve to give an even flow. Due to the high frequency excitation of the metering valve, the fluid delivery system still has sufficiently high bandwidth to respond to fast fluid flow changes commensurate with the load changes encountered in automotive applications. In most embodiments it is unnecessary, as the progressive phase change to vapor within the body (tube) of the atomizer results in a compressible (compliant) fluid column between the atomizer inlet and outlet.

Alternatively, a continuously proportional metering valve can be used to regulate the fuel flow. Such valves are also commonly used in the process industry, albeit usually not preferred in the automotive industry due to higher costs and more complex electrical control (variable DC voltage versus pulse-width modulation).

A large number of other liquid delivery systems can be envisioned which are suitable for use with the atomizer.

The methods of flow control described thus far effectively control the flow rate through the atomizer by a controllable obstruction (valve) upstream of the device. Alternatively, the flow control can be exercised downstream or near the exit of the atomizer by controlling the flow resistance at or near the exit of the device. Strictly from a flow control perspective, a pintle-style valve arrangement similar to arrangements used in pintle-style automotive fuel injectors, can be employed at the exit of the atomizer. However, precautions must be taken for this obstruction (pintle or equivalent) at or near the exit of the device not to interfere with the atomization process. In such case, the pintle (or flow restriction element) should be maintained at a temperature similar to that of the tube to maintain good atomization quality downstream of the device. Ideal embodiments for the flow restriction element (pintle or equivalent) are to be placed internal to the device, but near its exit, to act as a flow control valve, hence not interfering with the atomization process downstream of the device.

### The Control System

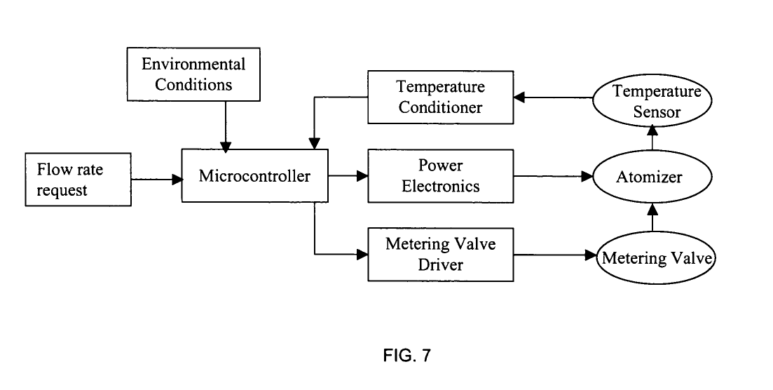

Control of the fuel system and the atomizer is crucial for proper operation. Without proper automated control, the device cannot function properly in automotive applications requiring a wide, dynamic adjustability. The schematic shown in FIG. 7 illustrates the basic framework of the control system. The control system allows the device to deliver varying amounts of fluid at different atomization levels as well as compensate for disturbances in the system and environmental conditions. The control system can be run from a 12 or 24 VDC source typical of current automotive applications. Other arbitrary voltages could be used without difficulty such as the newly emerging 42 VDC standard for automotive applications or high voltages such as the ones seen in hybrid-electric vehicles.

The microcontroller receives a flow rate command from the vehicle or the relevant sub-system (vehicle controller, engine control module, fuel cell system controller, etc.). Typical interface for such dedicated controller in the automotive industry is to communicate via a standard interface such as the CAN network protocol. Furthermore, such protocol also allows to use the same data bus to exchange information bi-directionally between the atomizer system controller and the rest of the vehicle or control network, such as, but not limited to, diagnostic information, status information, environmental variables, etc.

The microcontroller receives temperature feedback from the thermocouple (or equivalent temperature sensor) attached to the atomizer. This micro-controller can be a stand-alone controller, or imbedded in an existing controller, such as the engine control unit (ECU). This feedback is used to control the power electronics that provide the heating power to the atomizer. The power is modulated by using a pulse width modulation scheme. The frequency of the pulse width modulation (PWM) is such that it is much greater than the thermal time constant of the system. Therefore, the heat delivered to the tube is low-pass filtered. PWM is common to automotive systems, and represents a simple, cost effective means of controlling electrical power. The temperature of the fluid (or the tube) directly controls the level of atomization produced downstream of the device regardless of the incoming temperature of the liquid being atomized. This is particularly critical for automotive systems where liquid temperature can vary very significantly from −20° F. to over 100° F. Providing consistent atomization with automotive fluids (such as, but not restricted to, fuel, water, etc.) under this large range of temperature is a significant problem explicitly solved by this atomizer and its control system. Furthermore, by regulating the atomizer current by means of a temperature feedback, the amount of current (and hence heating) provided to the atomizer is self-adaptive to the flow rate of liquid being flown through the device. Again, this is critical to automotive applications where large dynamic changes in liquid flow rates are necessary. It also serves as a safety to prevent overheating of the atomizer in case of intentional or accidental lack of liquid flow. The low thermal inertia of the atomizer tube and the use of a (or multiple) small bead thermocouple (or equivalent temperature sensor(s)) as feed-back device(s) for the temperature makes the dynamic response of the atomizer and its control system suitable for automotive applications. Alternatively, in the case of resistive heating of the tube itself, electronics can be designed to measure the tube resistance (and hence its temperature) during the no-current part of the pulse-width current modulation, hence eliminating a sensor and directly using the tube temperature as a feedback signal.

The temperature information is also used to control the action of the metering valve through the metering valve power driver. In this manner, the system can compensate for variable flow rates, variable fuel inlet temperatures, and variable ambient conditions and variable fluid properties.

Another critical function of the controller is the ability to directly control the liquid flow rate. Like current implementations of flow control devices in automotive applications (fuel injectors, EGR valves, etc), this flow control function is at the minimum open-loop by providing either a pulse-width modulated signal or an analog voltage to the flow control element. In such open-loop control, the flow rate is set by the pulse width or amplitude of the control signal, possibly compensated in the micro-controller by the measurements of the pressure (or pressure differential) and temperature of the fluid feed-stream. In such case, additional sensors for the fluid/ambient temperature, the feed pressure of the liquid, discharge pressure and temperature may be required. For instance, if the pressure that the atomizer is discharging into is variable, it can cause the flow rate of the device to vary due to the difference in the differential pressure across the tube. This can be compensated for by the control system by measuring this pressure, and modifying the signal to the metering valve accordingly. Such additional sensors are already often imbedded in automotive applications. Alternative control configuration using either a direct or indirect measurement of the liquid flow rate can be used as a feedback signal.

A further feature of the control system is the ability to diagnose the status of the system. With the given system, it is possible to determine component failures in the fuel delivery system, atomizer system, and feedback path. Built-in, on-board diagnosis of automotive systems and sub-systems, particularly when they are likely to affect the safety and/or the emissions standards of vehicles are now mandated (OBD-II and sub-sequent standards). Hence, the micro-controller based control system described here is capable of implementing such diagnosis features.

### System Performance

In the embodiment using resistive heating of a coiled tube atomizer shown in FIG. 4 with strictly electrical heating (no external preheat), the following table summarizes the performance of the device with No 2 Diesel fuel:

| | |
|---|---|
| Peak Flow Rate: | 0.25 g/s peak |
| Power Consumption: | 300 W peak (1.2 kW/g/sec) |
| Atomization Level: | sub-micron |
| Low temperature operation: | <20 deg. F. |

In another embodiment of the atomizer using multiple glow plugs shown in FIG. 5 with strictly electrical heating (no external preheat), the following table summarizes the performance of the device with No 2 Diesel fuel:

| | |
|---|---|
| Peak Flow Rate: | 1.0 g/s peak |
| Power Consumption: | 1200 W peak (1.2 kW/g/sec) |
| Atomization Level: | sub-micron |

This does not represent the limits of the device or the atomization method. The concept can easily be extended to encompass other liquids or fluids as well as different flow rates and atomization levels. The embodiment of the device shown in FIG. 4 (and other embodiments) has successfully been used to finely atomized liquids such as water, gasoline and kerosene. The device is inherently scalable to match any flow rate requirements by changing the tube diameter and/or using multiple tubes in parallel. The electrical power requirements change accordingly and depend on the boiling temperature of the liquid at the pressure used in the device, the temperature of the liquid at the inlet of the device, the heat of vaporization of the liquid to be atomized, and the level of atomization required.

For reliable and consistently fine atomization such as it is dictated in many automotive applications, the heating should be such that all or substantially all the fluid is in vapor form at the exit plane of the atomizer. While lesser heating results in two-phase flow at the exit plane of the atomizer and the vapor mass fraction leads to very finely atomized liquid and help the liquid mass fraction to break into small droplets, a much wider particle size distribution results from such partial vaporization. For automotive applications where the larger liquid droplets are to be avoided (leading to increased wall wetting, poorer homogeneity, increased emissions (if applicable)), full vaporization of the liquid within the device is highly desirable, if not required.

The liquid atomization characteristics of the atomizer described above enables many processes in the field of automotive powertrains, including but not limited to, internal combustion engines in their various embodiments, fuel reformers, engine aftertreatment systems and fuel cell systems. By powertrain, we mean any and/or all of the components or sub-systems used in delivering or converting power (mechanically, electrically or chemically) aboard an automotive platform (such as, but not limited to, motorcycles, passenger cars, buses, trucks, off-highway autonomous equipment, special purpose vehicles, military vehicles, and by extensions, other equipment using similar powertrains, such as in-board and out-board boat engines, stationary generators, internal combustion engine-powered equipment, etc). These specific applications are described in the following paragraphs and fall into four broad categories: (1) Fuel preparation for specific modes of combustion in internal combustion engines; (2) Fuel and other liquid preparation for use in fuel reformers; (3) Fuel and other liquid preparation for specific modes of engine aftertreatment systems; and (4) Water preparation for internal combustion engines and fuel cell systems.

By fuel, we encompass all liquid chemicals susceptible to be used as a source of energy in internal combustion engines, reformers, engine after-treatment systems, or fuel cell systems through a process of chemical oxidation (partial or total) releasing energy as heat and/or electricity. Conventionally, these “fuels” encompass liquid hydrocarbons, either pure or in blends, such as gasoline, kerosene, Diesel fuel, “bio-Diesel”, alcohol blends etc. Of particular interest for use with the atomizer described here are the fuels which are hard to atomize by conventional means, mainly long-chain, heavy molecular weight hydrocarbons such as kerosene and Diesel (and so-called bio-Diesel) fuels. The atomizer described here, in its various possible embodiments, allows the ultra-fine atomization of these liquid fuels in preparation for combustion or partial oxidation processes as described below.

Also covered here, as dictated by the applications (and explicitly noted in the following paragraphs), are other liquids used in powertrain applications such as, but not limited to, water and water-urea solutions.

### Fuel preparation for Specific Modes of Combustion in Internal Combustion Engines

The ultra-fine atomization of the fuel by the atomizer and its delivery into an oxidizer gas (air or air/exhaust gas (EGR) mixture) allows the preparation of a very well mixed, homogeneous oxidizer/fuel mixture capable of combusting in a variety of modes:

Progressive flame triggered by a spark or by other means of local ignition, such as is encountered in spark-ignited (S.I.) engines;

Homogeneous charge compression ignition (HCCI , CAI, or equivalent combustion modes) engines where the ignition of the premixed oxidizer/fuel mixture simultaneously occurs in bulk at many points within the volume of interest simultaneously as a result of the temperature/pressure history and chemical kinetics;

Compression ignition (C.I.) engines (also referred to as Diesel engines) where the fuel (or some of the fuel) auto-ignites when sprayed at high pressure into a highly compressed and hot oxidizer mixture. The intended use of the atomizer in this combustion mode is not to address the conventional, direct injection of the fuel (or some of the fuel), but in the preparation of a dilute (very lean) homogenous mixture in which the high pressure direct injection portion of the fuel can auto-ignite.

Any combination of the above modes.

Regardless of the method of ignition (S.I, C.I., HCCI), the performance and emission characteristics of these combustion systems heavily depend on the ability of preparing a homogeneous oxidizer/fuel mixture (lean or stoichiometric, depending on the mode of ignition). While this is normally relatively easy to achieve with light fuels such as gasoline, this is not easily achieved during cold engine starts with heavy fuels, particularly under very cold ambient temperatures (resulting in very significant hydrocarbon emissions in S.I. engines during the initial cold starts). While not needed during warm operation with light fuels, the atomizer can be used as a starting aid or supplemental fuel injection system for (very) cold starts with light fuels such as gasoline and alcohol blends. Under cold conditions, in applications using conventional fuel injectors in the throttle body, or intake port or directly in the cylinder of internal combustion engines, it is difficult, if not impossible, to achieve good atomization with heavy fuels such as kerosene and Diesel fuels. Conventional methods of fuel atomization lead to droplet sizes which are too large to prepare a stable oxidizer/fuel mixture which does not lead to rapid liquid fuel film formation (wall wetting), and capable of preparing a mixture which is capable of rapidly evaporating during subsequent compression. This has severely hampered the use of heavy fuels in SI engines and HCCI engines and in mixed mode CI engines.

The atomizer delivers such small droplets (below 1 micron) such that:

its mixing behavior is gas-like with very high dispersion rate, enabling the preparation of very homogeneous mixtures,

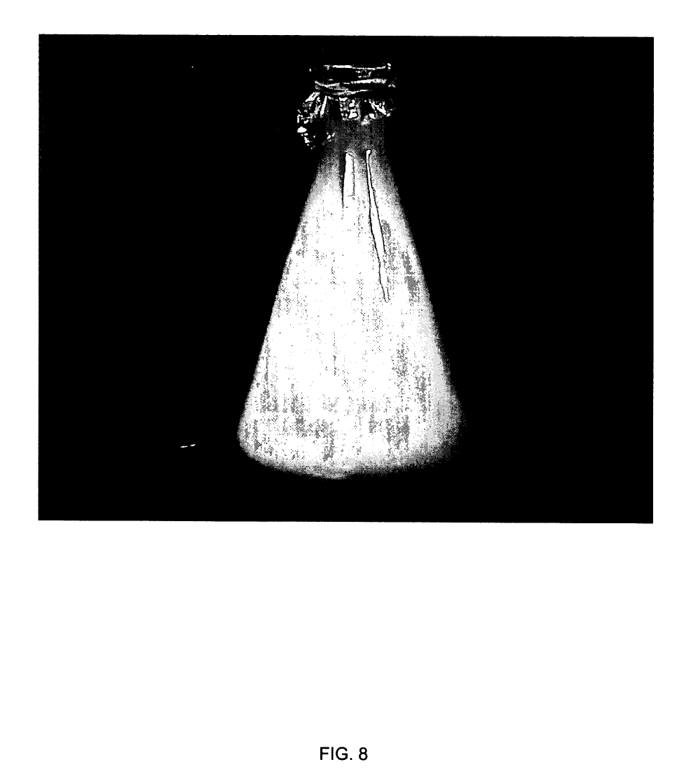

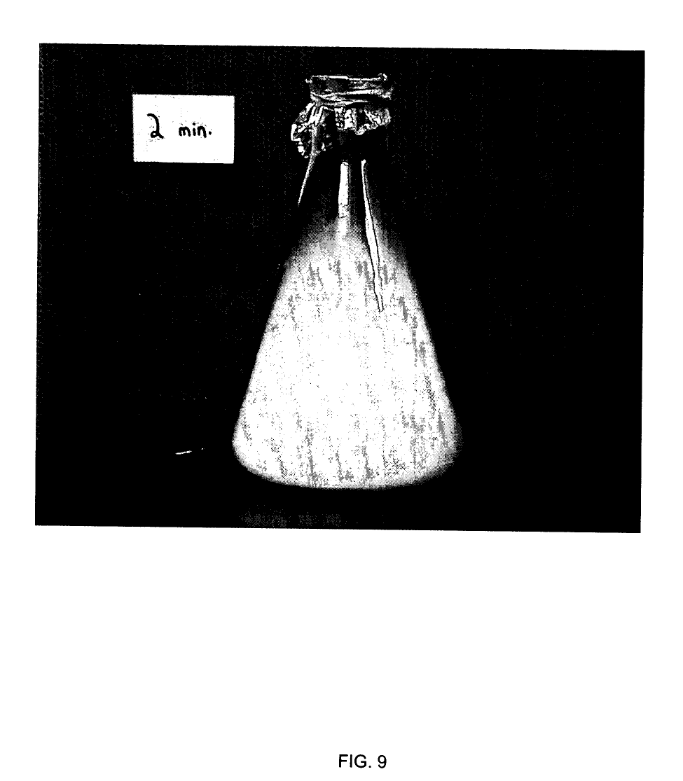

the mixture is non-settling, leading to virtually no fuel film formation on surfaces (Compare FIGS. 8 and 9—time-lapse photographs of finely atomized Diesel fuel in air at ambient temperature and pressure conditions);

the fuel can evaporate very rapidly due to the very high surface to volume ratio due to the very small droplet size.

All of these characteristics are critical in allowing the preparation of a very homogeneous mixture of oxidizer and fuel in the intake manifold or port of an engine and its transport (convection) by the usual gas transfer into the cylinder without significant wall wetting, settling, or segregating (source of inhomogeneity). Furthermore, these characteristics enable the subsequent rapid evaporation of the fuel to create a highly mixed and homogeneous oxidizer/fuel vapor mixture with reliable and easy ignition characteristics.

In summary, the atomizer enables the following combustion systems:

cold start “aid” in light fuels in conventional (homogeneous-charge, port- or throttle-body injected) SI engines,

the sole or one of the fuel delivery systems for heavy fuels such as kerosene in (homogeneous-charge, port or throttle body injected) SI engines,

the sole or one of the fuel delivery systems for heavy fuels like Diesel fuel in compression ignition (CI) engines, either to prepare an homogenous oxidizer/fuel mixture to combust in HCCI mode, or to prepare an homogeneous, very dilute mixture incapable of auto-igniting on its own, in which high pressure, direct injection of additional fuel (as used in conventional Diesel engines) enables auto-ignition and diffusion mode of combustion around each droplet. This mixed mode of combustion has the advantage of allowing a richer fuel/oxidizer mixture to burn in Diesel engines without encountering soot formation, a major limitation to high load in CI engines, effectively limiting the A/F ratio to about 18 or 25.

As a supplementary fueling system used in CI engines to enable HCCI combustion mode at or near idle. In this application, the atomizer is used as a supplementary fueling system delivering atomized fuel into the intake manifold or individual intake runners or intake ports in an otherwise conventional direct injection CI engine. This system can be used as a new feature on new CI engines, or as a retrofit for existing CI engines. Enabling HCCI combustion with external mixture preparation instead of conventional CI combustion leads to dramatically reduced emissions of NOx.

In addition to HCCI combustion at or near idle, the atomizer can be used for HCCI combustion with external mixture preparation up to significant, if not all, engine loads and at all engine speeds, with and without EGR dilution. The high homogeneity of the air/fuel/EGR mixture in the cylinder achieved with the atomizer results in a relative insensivity if the combustion timing in HCCI to factors such as charge temperature, EGR dilution, air-fuel ratio, boost pressure and engine speed. Furthermore, the HCCI combustion mode with external mixture preparation enabled by the atomizer is continuously superposable to the conventional CI combustion mode (with direct injection) over a wide range of speeds and loads. This key feature considerably simplifies engine control system development and avoids the difficult “mode switching” required with other embodiments of HCCI combustion with internal mixture preparation.

### Fuel/Liquid Preparation for Use in Fuel Reformers

Fuel reformers refer to a broad class of devices which represent chemical reactors specifically designed to transform a fuel into another fuel or mixture of fuels. In automotive applications, such fuel reformers can be used to produce hydrogen or hydrogen-rich fuel from liquid hydrocarbon fuels (methanol, ethanol, gasoline, Diesel fuel, etc). The output of such fuel reformers can be fed to fuel cell systems (PEM, SOFC, etc), or directly used as fuels in combustion engines (i.e., providing a more reactive or cleaner burning fuel), or for other applications related to engines such as after-treatment systems (see later section).

While there are many types of fuel reformers, these devices rely upon reacting the fuel with a feed gas (air, or exhaust stream, etc.) and/or water/steam in the presence of a catalyst or catalysts which promote(s) the chemical reactions of interest (pyrolysis, partial oxidation, water-gas shift, etc) to yield a reformate output stream with the composition of interest. Like all chemical reactors, the reactions can only occur if the reactants are intimately mixed, and well distributed over the catalyst surface. In the case of long molecular chain hydrocarbons such as the ones found in liquid heavy fuels like Diesel fuel, it is very difficult to achieve an intimate mixing of the fuel with the reactant gas stream. The process typically involves liquid injection and atomization, dispersion and mixing of the liquid droplet, subsequent vaporization of the droplets and mixing/molecular diffusion of the fuel vapor in the air/exhaust/water vapor) prior to reaction on the surface of the catalyst. Similarly in reformers which use water as one of the reactants, water is typically vaporized externally and injected as steam to achieve good dispersion and reactivity. The use of the atomizer for water injection enables considerable simplification of the system by eliminating the steam generator, and thus may provide better thermal synergy for exothermic reactions as the process of water evaporation is internal to the reformer, as opposed to external in a steam generator. Owing to spatial constraints (packaging) and temporal constraints (residency time), all these processes must occur very rapidly and efficiently. Owing to the properties of the atomized stream delivered by the atomizer and the properties of the ultra-fine suspension with results, the atomizer can significantly enhance fuel delivery, mixing and vaporization of the fuel for use in fuel reformers or other related chemical reactors. This can lead to the compact packaging of reformers, the optimal use of catalyst sites available (cost reduction) due to excellent dispersion, fast responding reformers under transient conditions (a very difficult problem for automotive applications such as engines and fuel cells where the load constantly changes), and quick start-up times fuel delivery system capable of achieving excellent atomization and mixing, and no wall-wetting or liquid pooling under “cold start” conditions.

### Fuel Preparation for Specific Modes of Engine Aftertreatment Systems

### Introduction

Many of the modern advances in combustion engines have been driven by pollutant emission standards. Despite many advances at the engine level, it is generally accepted that that sophisticated after-treatment systems are required to meet current or upcoming emission regulations. Furthermore, passive after-treatment systems, such as the 3-way catalyst used in the last 25 years in conventional S.I. engine, cannot fully fulfill their emission reduction role (and hence allow vehicles or engines to meet emission standards), either because of thermal effects (light-off upon cold starts) or chemical effects (NOx treatment in lean-burning engines, such as lean-burn Spark Ignited (SI), stratified charge spark ignited (SIDI or GDI) and Compression Ignited (CI) or Diesel). This has led to a wide variety of proposed or implemented exhaust after-treatment systems which are complex and most often require an active thermo-chemical management, i.e., the addition of heat and/or fuel or reducing agent into the exhaust stream. This leads to very significant technology challenges to provide simple, effective and energy efficient methods for delivering heat, and/or fuel and/or other reductants to the exhaust stream. By lack of convenient “actuators” for such delivery, many systems rely upon modifying the engine control strategy during specific phases of operation away from optimal conditions for the sole purpose of generating exhaust gases with the proper composition and/or temperature. The atomizer enables many possible paths for various after-treatment strategies to decouple the thermo-chemical management of the after-treatment system from the engine. This leads to both gains in overall energy efficiency (gas mileage) and in ease in control system design and implementation for the overall powertrain. The paragraphs below describe some representative (but not the only) specific potential applications of the atomizer system for exhaust after-treatment applications.

### Difficulties in Exhaust Injection of Hydrocarbon Fuels

The injection of hydrocarbon fuel is a common need in the aftertreatment systems of the future. In the case on Lean NOx Traps (LNT's), the hydrocarbons are typically injected for making the exhaust fuel-rich. As stated above, this can be performed by injecting excess fuel into the engine by affecting the engine control strategy or by injecting fuel downstream of the engine into the exhaust stream. However, reductant delivery to the exhaust of an IC engine is difficult. Heavy fuels, like Diesel, present a significant challenge due to their tendency to condense and difficulty achieving proper atomization. These issues can lead to puddling of fuel, mal-distribution of fuel droplets in the exhaust stream, pitting of catalyst surface from droplet impaction, coking of exhaust walls and catalyst surfaces, and other critical problems. The atomizer described above offers a solution to these problems by enabling a very homogeneous exhaust gas/fuel mixture to be formed, with excellent transport and mixing characteristics and very rapid evaporation dynamics due to the high surface to volume ratio of the sub-micron droplets. This is particularly critical in practical exhaust systems in vehicles where space is very confined and the injection point(s) must often be only a short distance upstream of the targeted after-treatment component. The availability of a well mixed hydrocarbon/exhaust gas mixture, with all the hydrocarbon available in vapor phase is critical for the reactivity of the mixture over the entire face of the catalyst and hence optimal usage of all the available catalyst sites.

The following sections outline benefits to existing aftertreatment technology. The list is not comprehensive, and only serves to represent some areas in which the atomize system of the present invention offers improvements over existing technology.

### Lean NOₓ Catalysts/DeNOₓ Catalysts

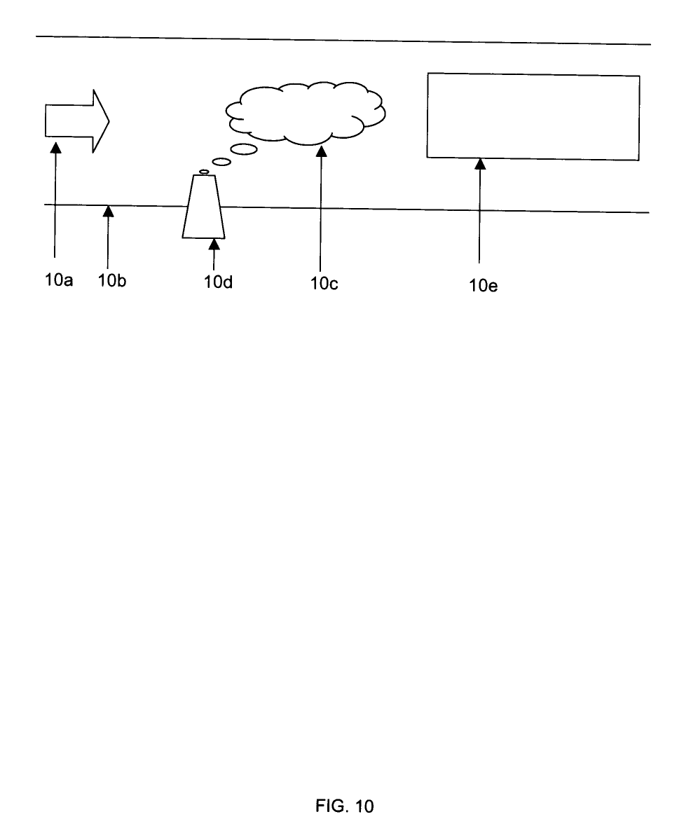

This type of catalysts requires the presence of hydrocarbons to react with oxides of nitrogen over a catalyst. It is necessary to inject additional hydrocarbons into the exhaust stream upstream of the Lean NOx Catalysts. Research has shown that the level of atomization is an important factor in the NOx removal efficiency of such a system. FIG. 10 is a schematic of one embodiment of a lean NOₓ catalyst system the present invention. As shown in FIG. 10, as the exhaust gas stream 10a flows through the exhaust conduit 10b, the nitrogen oxide-rich exhaust stream is injected with hydrocarbons 10c by atomizer 10d. The injected hydrocarbons 10c react with the nitrogen oxides in the exhaust stream at the catalyst 10e thereby reducing the concentration of nitrogen oxides in the exhaust stream downstream of the catalyst.

### Non-Thermal Plasma Systems

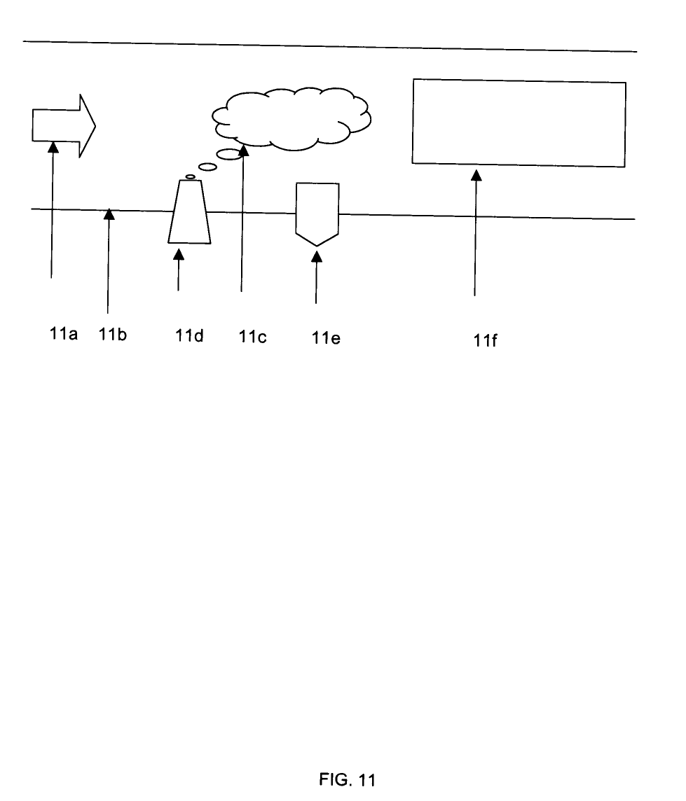

Non-thermal plasma systems operate similarly to the above-mentioned Lean NOx Catalysts system. Hydrocarbons are injected upstream of a non-thermal plasma generator and catalysts. The non-thermal plasma and catalysts promote the chemical reactions necessary for the elimination of emission species. FIG. 11 is a schematic of one embodiment of a non-thermal plasma system of the present invention. As shown in FIG. 11, as the exhaust gas stream 11a flows through the exhaust conduit 11b, a hydrocarbon emission 11c is injected in to the exhaust stream by atomizer 11d upstream of a plasma generator 11e and catalyst 11f.

### Lean NOₓ Traps/NOₓ Adsorber Catalyst

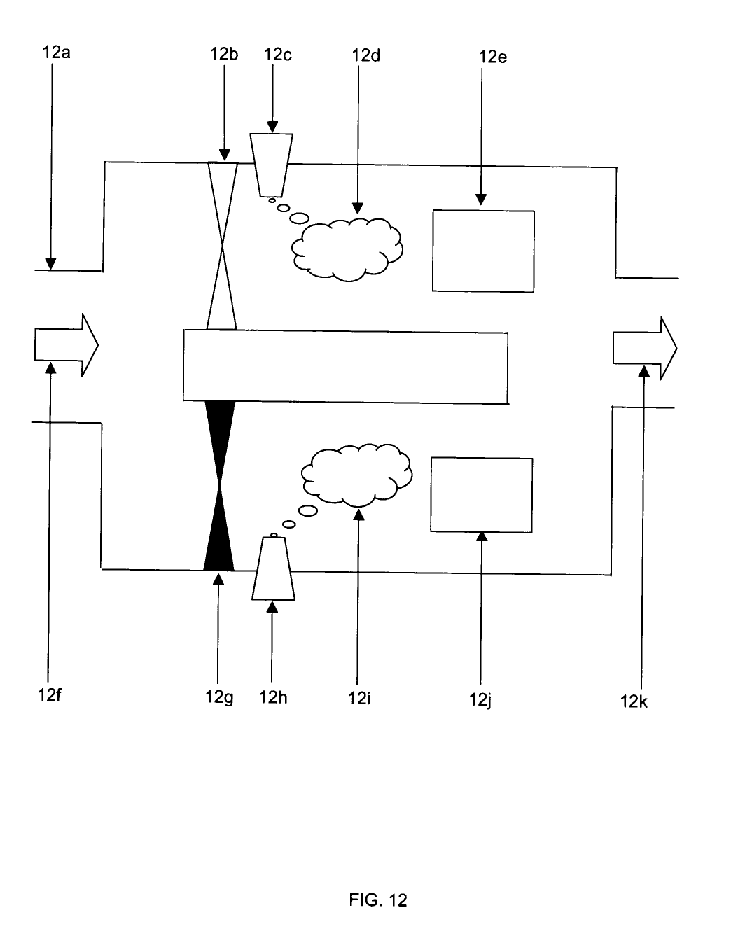

Lean NOₓ traps systems can also benefit from use of the atomizer. In a bifurcated Lean NOₓ trap system, hydrocarbon fuel is used to provide rich conditions for the release and reduction of the stored NOₓ on the catalysts. A high degree of atomization is necessary for such a system to be practical. FIG. 12 is a schematic of one embodiment of a lean NOₓ trap system of the present invention for the case of a bifurcated system. As shown in FIG. 12, as the exhaust stream 12f flows through the exhaust conduit 12a and is divided into 2 equal streams (branches). The flow in each branch in controlled by a valve (12b and 12g, respectively), which allow the exhaust flow to toggle between the two branches. In each branch, a hydrocarbon emission 12d (or 12i) is injected into the exhaust stream by an atomizer 12c (or 12h) upstream of a Lean NOx trap catalyst 12e (or 12j). The flows are recombined into a common exhaust downstream of the catalyst. With such configuration, the active branch where exhaust gases flow absorbs the oxides of Nitrogen, while in the other branch the atomizing system delivers a fine mist of hydrocarbons to the face of the other catalyst, hence allowing reduction reaction to occur and purging the Lean NOx trap of the nitric oxides. After some interval, the valves reverse the role of the branches. Since the atomizing system delivers hydrocarbons to the catalyst in the absence (or near absence) of a flow of exhaust gases, the reduction reaction in this hydrocarbon rich environment is very effective.

### Urea-SCR Systems

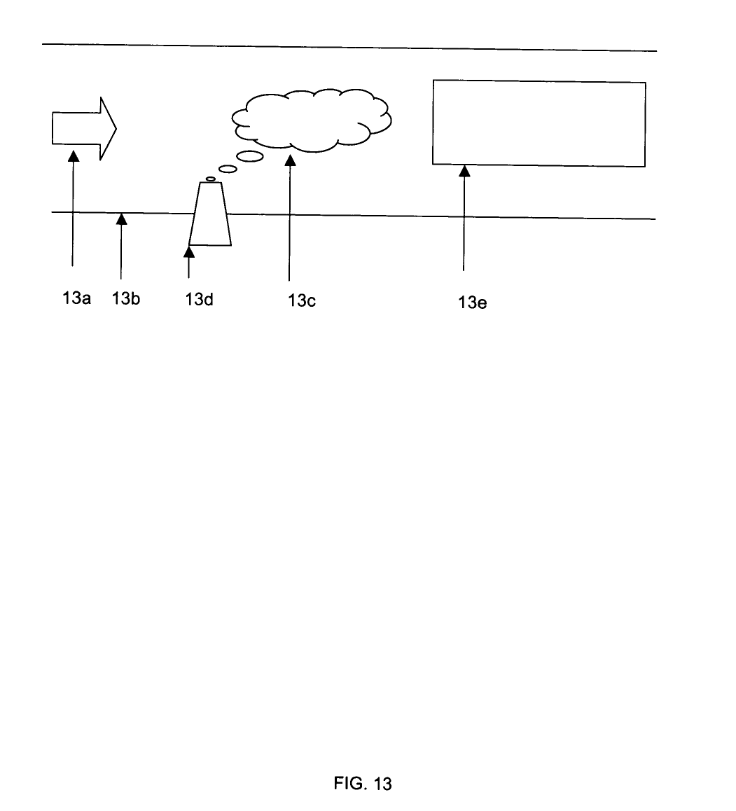

Urea-SCR systems require the injecting of a water-urea solution into the exhaust upstream of the SCR catalysts. The injected urea solution then thermally decomposes into ammonia that is then used by the downstream SCR catalysts to reduce NOx emissions. One of the critical issues in such a system is providing a long enough residence time in the exhaust to allow the urea to thermally decompose and to get proper mixing. The heated atomizer described above would heat the urea solution above its decomposition point, promoting the thermal decomposition of the solution. In addition, the atomizer provides superior atomization quality for rapid droplet evaporation and good mixing properties. FIG. 13 is a schematic of one embodiment of a urea-SCR system of the present invention. As shown in FIG. 13, as an exhaust gas stream 13a flows through an exhaust conduit 13b, a urea solution emission 13c is injected into the exhaust stream by the atomizing system 13d, where the urea decomposes into ammonia which is used downstream by the SCR catalyst 13e to reduce NOₓ.

### Particulate Trap Systems

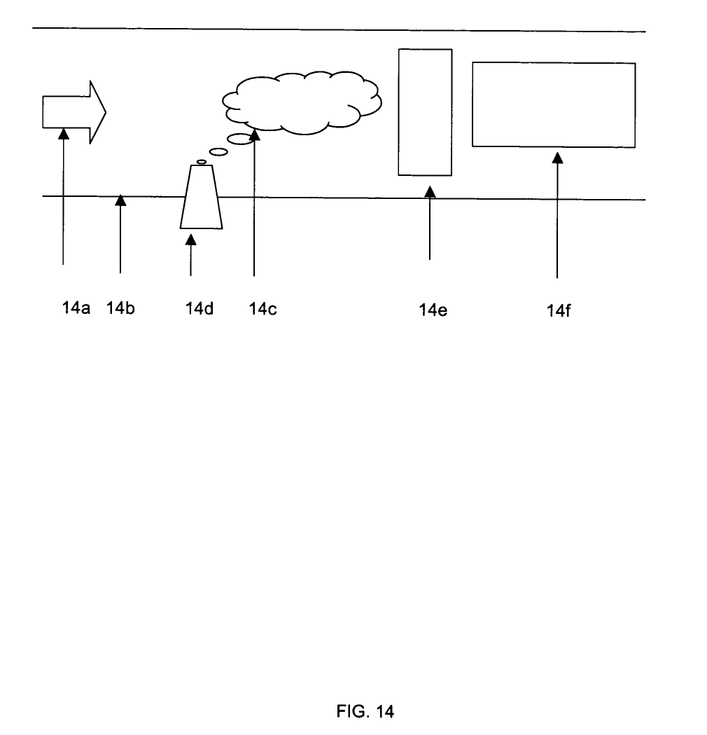

Regeneration of particulate trap systems requires the generation of a large amount of heat. This heat can be generated by injecting hydrocarbons into the exhaust and then generating an exotherm over a catalyst to provide heat. As in the above applications, the atomizer offers a benefit over existing atomizing technology for this application. FIG. 14 is a schematic of one embodiment of a particulate trap system of the present invention. As shown in FIG. 14, as an exhaust gas stream 14a flows through an exhaust conduit 14b, a hydrocarbon emission 14c is injected by atomizer 14d into the exhaust stream on a catalytically coated catalytically coated oxidation catalyst 14e followed by a particulate filter 14f. The presence of the fuel at an elevated temperature in an otherwise oxygen rich environment in the presence of a catalyst causes an exotherm leading to the combustion of the particulate trapped in the filter. A related embodiment is to combine the oxidation catalyst 14e and the particulate filter 14f into one unit in the form of a catalytically coated particulate filter. In either case, the use of the atomizing system upstream to generate a mist of hydrocarbons is identical.

### Rapid Light-Off Strategies

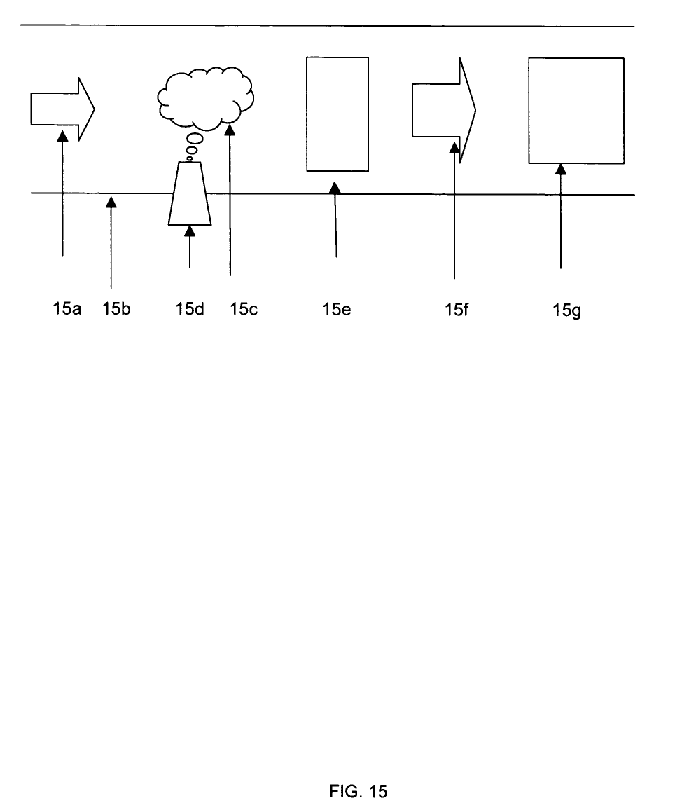

Hydrocarbons injected into the exhaust stream can also be used to generate heat to bring downstream catalysts up to temperature rapidly. In such a system, a small, low thermal inertia catalysts, or an electrically heated catalysts are used to oxidize the fuel to generate the necessary heat to warm up larger catalysts downstream. In this way, the large catalyst can be brought up to operating temperature much faster. FIG. 15 is a schematic of one embodiment of a rapid light-off system of the present invention. As shown in FIG. 15, as exhaust gas stream 15a flows through an exhaust conduit 15b, atomizer 15d injects a hydrocarbon emission 15c into the exhaust stream. The hydrocarbon emission 15c encounters a small, low thermal inertia catalysts (or an electrically heated catalysts) 15e where it is oxidized—thereby releasing heat. The heated exhaust stream 15f subsequently heats catalyst 15g.

### Fuel Reformer Applications for Aftertreatment

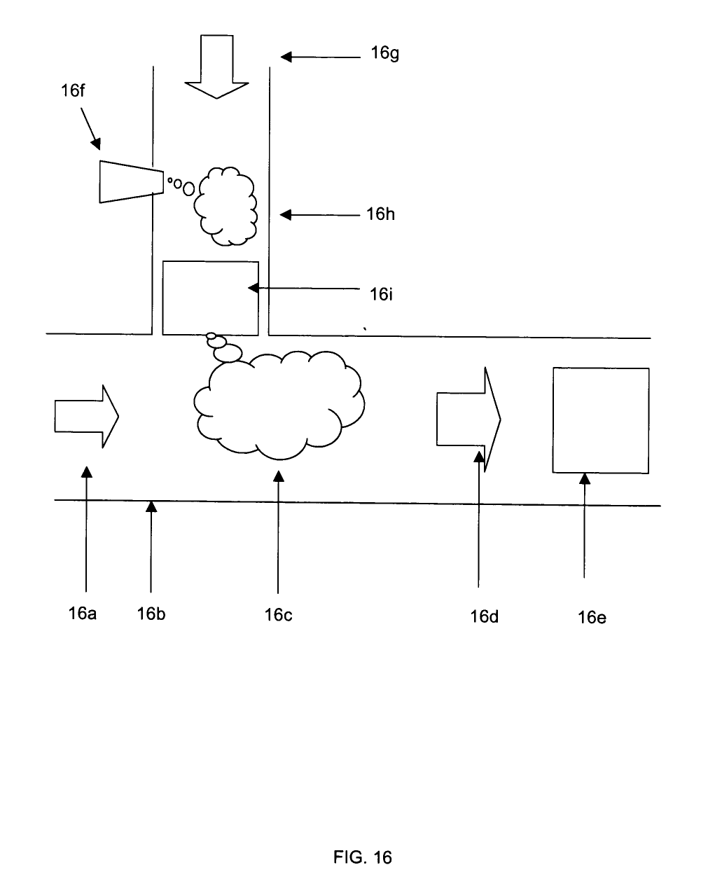

In many of the after-treatment applications listed above, where the primary aim of injecting hydrocarbons is to provide a reductant to promote specific chemical reactions such as trap LNT regeneration, research has clearly indicated that long-chain hydrocarbons are not the most efficient reductant, and that chemical species like carbon monoxide (CO) and hydrogen (H₂) are far more effective reductants. Long chain hydrocarbons, if used as reductants, must first undergo many reactions (pyrolysis and subsequent partial oxidation or reforming) to yield more reactive species. One of the possible applications of the atomizer is its use for hydrocarbon injection in a partial oxidation catalytic reactor to yield a H₂- or CO-rich stream, which can then be fed to specific exhaust aftertreatment components. This application is similar to the fuel reforming applications described earlier. FIG. 16 is a schematic of one embodiment of a fuel reformer application for an aftertreatment system of the present invention. As an exhaust gas stream 16a flows through an exhaust conduit 16b, a side branch introduces high reactivity reductants 16e into the exhaust stream 16d on the catalyst 16e. The high reactivity reductants 16c are produced in the side branch acting as a separate fuel reformer. In this fuel reformer, hydrocarbons 16h are injected by the atomizing system 16f into an air stream 16g and this mixture is partially oxidized over an oxidation catalyst, hence providing a H₂ or CO-rich stream of reductant which mixes into the main exhaust gas stream.

### Rich Combustor for Reductant Formation

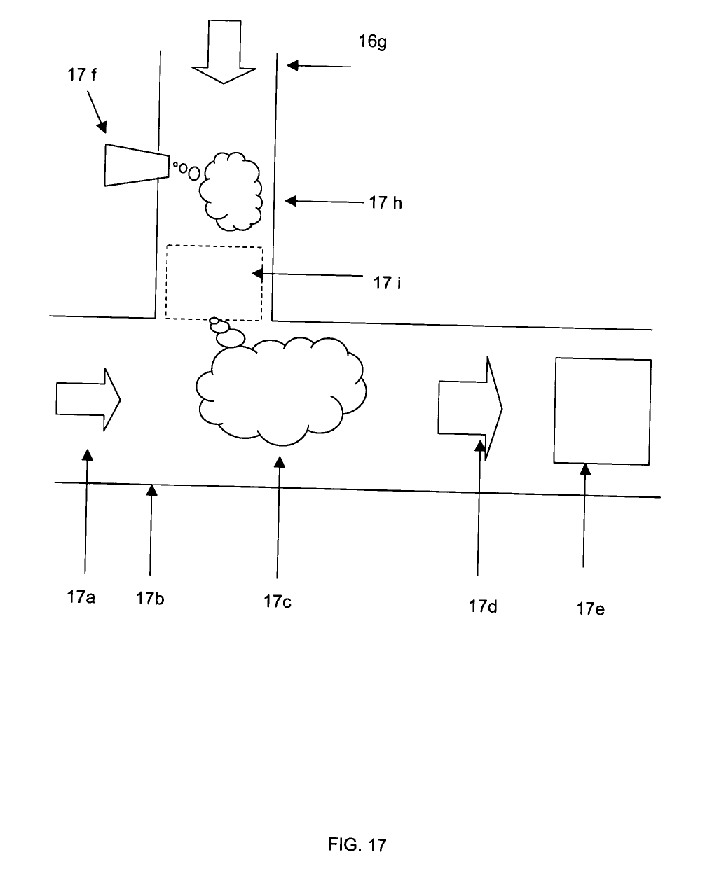

The atomizer can also be used for the purpose described above (i.e., producing a reductant-rich stream to feed to after-treatment systems such as LNT's), but without using a fuel reformer or partial oxidation catalytic combustion process, but directly as a combustor operating very rich. Similar to a fuel reformer or partial oxidation catalyst, the hydrocarbon fuel burns (pre-mixed or diffusion flame) in an oxidizer stream, which can be provided by the lean exhaust (or a diverted portion) of a CIDI or SIDI engine, or the secondary air stream provided by an auxiliary air pump. The combustion by product of this rich to very rich combustion include a temperature rise (ideal to raise exhaust temperatures to the proper window of operation of the after-treatment catalyst and a CO- and H₂-rich stream to provide the ideal reductants for the catalyst regeneration. FIG. 17 is a schematic of one embodiment of a rich combustor system for reductant formation of the present invention. FIG. 17 is similar to FIG. 16, except that the oxidation catalyst 16i is replaced by a rich combustion zone 17i, yielding a high concentration of H₂ and CO reductants.

Water Injection for Fuel Cell Systems and Engine Applications

In addition to fuels, the atomizer can be used for atomizing other liquids such as water for two distinct applications (but not limited to): humidification/cooling in fuel cell systems and water injection in engines for NOx reduction.

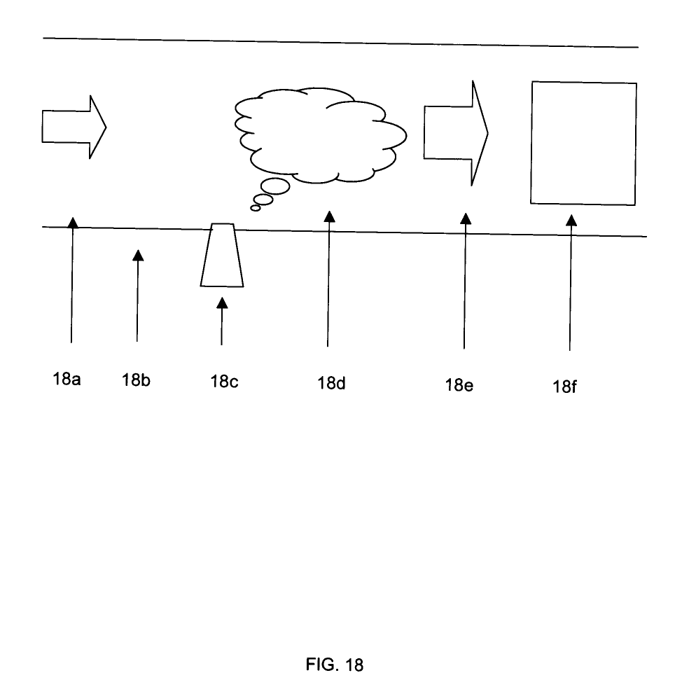

Humidification of incoming air streams near saturation at temperatures ranging from 50 to 85° C. is very difficult to achieve in compact devices. However, humidification is critical for the proper functioning of membranes in PEM (Proton Exchange Membrane) fuel cells. Furthermore, in commonly-used pressurized systems, the water injection is often required not only to achieve humidification requirements but also to cool the exit stream of the compressor prior to enter the fuel cell. Water injection strategy typically used use high pressure nozzle to spray liquid droplets into the air stream. The relatively large water droplets (typically 5-10 microns in diameter) have very poor evaporation characteristics resulting only in a small percentage of the water injected increasing the air moisture content. This humidification by water injection is typically carried downstream of the compressor. Water droplets which do not fully vaporize in the air stream represent a significant problem with respect to flooding of the fuel cell and blocking of the very small air passages in the bipolar plates. Ideally, water injection should occur upstream or within the compressor to lower the air temperature rise due to compression and reduce the parasitic work of the air compressor. However, most compressors are damaged by the impact of liquid water droplets on the blades or rotors, rendering this injection technique often impractical. The atomizer provides an ideal means of achieving humidification of air stream (pre- or post-compressor) in fuel cell systems. The very high surface-to-volume ratio obtained with the sub-micron droplet sizes exiting form the atomizer results in very fast evaporation dynamics, as well as good dispersion and mixing and absence of targeting of neighboring surfaces by very low-momentum droplets. Furthermore, in pre-compressor water injection, the sub-micron droplets do not damage the compressor rotors or blades, making it the ideal water injector for achieving air humidification and compressed air cooling (and decreased compressor work). FIG. 18 is a schematic of one embodiment of the present invention for a water injection system for humidification in fuel cell systems. An air stream 18a flows through an air conduit 18b. Atomizer 18c injects a very fine mist of water droplets which thoroughly mixes with the air 18e entering a compressor 18f. Alternatively, the atomizer 18c can be located at the inlet of the compressor, or at a point within the compressor, as well as downstream of the compressor. The very rapid evaporation dynamics of the sub-micron droplets generated by the atomizer lead to a very rapid humidification of the air stream to very high humidity level, and with very fast humidity response time when air flow rate change rapidly, such as in automotive traction application during rapid vehicle (load) transients.

The same properties of the finely atomized water can be used for use for water injection on engines to reduce NOx emissions. Substantial NOx reduction by water injection in engines is not new and has been amply demonstrated. However, in the case of external water injection in the intake manifold and/or individual intake runners or ports, the very small droplets generated with the atomizer achieve all the benefits listed above: excellent dispersion of the water in the air charge leading to homogeneity of the intake charge and resulting lower unburned hydrocarbons (a common side effect of water injection by conventional means is an increase in unburned hydrocarbons), rapid evaporation dynamics and no wall wetting by liquid water droplets resulting in liquid water film formation.

In view of the present disclosure or through practice of the present invention, it will be within the ability of one of ordinary skill to make modifications to the present invention, such as through the use of equivalent arrangements and compositions, in order to practice the invention without departing from the spirit of the invention as reflected in the appended claims.

What is claimed is:

1. A system for producing a mist of sub-micron sized fluid droplets, said system comprising:
an atomizer, said atomizer comprising:
a fluid conduit for transporting a pressurized supply of a fluid, said fluid conduit having an inlet and an outlet, wherein said outlet discharges said fluid into a discharge zone; and
a heating element that delivers sufficient thermal energy to said fluid traversing said fluid conduit such that the vapor pressure of said fluid is greater than the pressure in said discharge zone so as to cause said fluid to atomize in said discharge zone thereby producing a mist of sub-micron sized fluid droplets;
a temperature sensor, said temperature sensor in thermal contact with said fluid so as to determine the temperature of said fluid;
a flow control element in fluid communication with said atomizer, said flow control element controlling the volumetric flow rate of said fluid; and
a controller, said controller in electrical communication with said temperature sensor, said flow control element, and said heating element, said controller capable of adjusting said heating element's delivery of thermal energy to said fluid in response to said temperature of said fluid and said volumetric flow rate of said fluid, said controller capable of causing said flow control element to adjust said volumetric flow rate of said fluid.

2. The system according to claim 1 wherein said heating element is a glow plug.

3. The system according to claim 1 wherein said heating element is an external heat source.

4. The system according to claim 1 wherein said fluid conduit is capillary tubing.

5. The system according to claim 4 wherein said fluid conduit comprises two electrical contacts for applying an electrical current so as to use said fluid conduit as a resistive heater.

6. The system according to claim 1 wherein said fluid conduit is a coiled tube.

7. The system according to claim 6 wherein said fluid conduit is used as a resistive heater by applying an electrical current between two points along said fluid conduit.

8. The system according to claim 1 wherein said temperature sensor measures the temperature of said fluid at said outlet.

9. The system according to claim 1 wherein said temperature sensor measures the temperature of said fluid conduit.

10. The system according to claim 1 wherein the electrical resistance of said fluid conduit provides a temperature measurement of said fluid conduit.

11. An engine comprising the system according to claim 1.

12. A vehicle comprising the system according to claim 1.

13. A fuel reformer comprising the system according to claim 1.

14. An air delivery system for a fuel cell system comprising the system according to claim 1.

15. A fluid delivery system, said fluid delivery system comprising:
a pressurized supply of a fluid, wherein the inlet pressure of said fluid is higher than the discharge pressure of said fluid;
a flow control device, said flow control device in fluid communication with said pressurized supply of a fluid, said flow control device actuating in response to a signal so as to open said flow control device thereby permitting said fluid through said flow control device;
an atomizer, said atomizer in fluid communication with said flow control device so as to receive said fluid from said flow control device at a desired volumetric flow rate, said atomizer comprising:
a fluid conduit for transporting a pressurized supply of a fluid, said fluid conduit having an inlet and an outlet, wherein said outlet discharges said fluid into a discharge zone; and
a heating element in thermal contact with said fluid conduit such that said heating element delivers sufficient thermal energy to said fluid traversing said fluid conduit such that the vapor pressure of said fluid is greater than the pressure in said discharge zone so as to cause said fluid to atomize in said discharge zone thereby producing a mist of sub-micron sized fluid droplets;
a temperature sensor, said temperature sensor in thermal contact with said fluid so as to determine the temperature of said fluid; and
a controller, said controller in electrical communication with said temperature sensor and said heating element, said controller capable of adjusting said heating element's delivery of thermal energy to said fluid in response to said temperature of said fluid and said desired volumetric flow rate.

16. The fluid delivery system according to claim 15 wherein said pressurized supply of a fluid has a pressure higher than the discharge pressure of said fluid conduit.

17. The fluid delivery system according to claim 15 wherein said signal is a pulse width modulated signal.

18. The fluid delivery system according to claim 15 wherein said signal is an analog signal.

19. The fluid delivery system according to claim 15 wherein said flow control device is a fast acting solenoid valve.

20. The fluid delivery system according to claim 15 wherein said flow control device is a servo-valve.

21. The fluid delivery system according to claim 15 wherein said flow control device is an electrically controllable flow restriction

22. The fluid delivery system according to claim 15 wherein said flow control device is placed upstream of the said fluid conduit

23. The fluid delivery system according to claim 15 wherein said flow control device is placed downstream of the said fluid conduit

24. The fluid delivery system according to claim 15 wherein said flow control device is placed within the said fluid conduit

25. An engine comprising the fluid delivery system according to claim 15.

26. A vehicle comprising the fluid delivery system according to claim 15.

27. A fuel reformer comprising the fluid delivery system according to claim 15.

28. A system for treating an exhaust stream by injecting an atomized spray, said system comprising:
an exhaust stream, said exhaust stream comprising at least one chemical species to be treated, said at least one chemical species having an initial concentration;
a flow control device, said flow control device in fluid communication with a pressurized supply of a fluid, said fluid control device actuating in response to a signal so as to open said flow control device thereby permitting said fluid through said flow control device;
an atomizer, said atomizer in fluid communication with said flow control device so as to receive said fluid from said flow control device at a desired volumetric flow rate, said atomizer comprising:
a fluid conduit for transporting a pressurized supply of a fluid, said fluid conduit having an inlet and an outlet, wherein said outlet discharges said fluid into said exhaust stream; and
a heating element in thermal contact with said fluid conduit such that said heating element delivers sufficient thermal energy to said fluid traversing said fluid conduit such that the vapor pressure of said fluid is greater than the pressure in said exhaust stream so as to cause said fluid to atomize in said exhaust stream thereby producing a mist of sub-micron sized fluid droplets;
a temperature sensor, said temperature sensor in thermal contact with said fluid so as to determine the temperature of said fluid;
a controller, said controller in electrical communication with said temperature sensor and said heating element, said controller capable of adjusting said heating element's delivery of thermal energy to said fluid in response to said temperature of said fluid and said desired volumetric flow rate; and
a catalyst, said catalyst chemically interacting with said at least one chemical species so as to treat said at least one chemical species thereby diminishing said initial concentration of said at least one chemical species.

29. A catalytic system for treating at least one chemical species, said catalytic system comprising:
an exhaust stream comprising at least one chemical species, said exhaust stream directed towards a catalyst;
a catalyst for chemically treating said at least one chemical species;
a flow control device, said flow control device in fluid communication with a pressurized supply of a fluid, said flow control device actuating in response to a signal so as to open said flow control device thereby permitting said fluid through said flow control device;
an atomizer, said atomizer in fluid communication with said flow control device so as to receive said fluid from said flow control device at a desired volumetric flow rate, said atomizer comprising:
a fluid conduit for transporting a pressurized supply of a fluid, said fluid conduit having an inlet and an outlet, wherein said outlet discharges said fluid into said exhaust stream; and
a heating element in thermal contact with said fluid conduit such that said heating element delivers sufficient thermal energy to said fluid traversing said fluid conduit such that the vapor pressure of said fluid is greater than the pressure in said exhaust stream so as to cause said fluid to atomize in said exhaust stream thereby producing a mist of sub-micron sized fluid droplets;
a temperature sensor, said temperature sensor in thermal contact with said fluid so as to determine the temperature of said fluid; and
a controller, said controller in electrical communication with said temperature sensor and said heating element, said controller capable of adjusting said heating element's delivery of thermal energy to said fluid in response to said temperature of said fluid and said desired volumetric flow rate.

30. The catalytic system according to claim 29 additionally comprising at least one non-thermal plasma generator disposed upstream of said catalyst and downstream of said atomizer.

31. The catalytic system according to claim 29 additionally comprising at least one secondary catalyst upstream of said catalyst, said at least one secondary catalyst selected from the group consisting of: low thermal inertia catalysts and electrically heated catalysts, said secondary catalyst capable of producing heat from a chemical reaction when said atomizer introduces said mist of sub-micron sized fluid droplets into said exhaust stream, said heat subsequently acting to raise the temperature of said catalyst downstream.

32. The catalytic system according to claim 29 wherein said fluid is an aqueous urea solution and said catalyst is a SCR catalyst.

33. A system for humidifying an air stream for use in a fuel cell, said system comprising:
an air stream;
a flow control device, said flow control device in fluid communication with a pressurized supply of a fluid, said flow control device actuating in response to a signal so as to open said flow control device thereby permitting said fluid through said flow control device;
an atomizer, said atomizer in fluid communication with said flow control device so as to receive said fluid from said flow control device at a desired volumetric flow rate, said atomizer comprising:
a fluid conduit for transporting a pressurized supply of a fluid, said fluid conduit having an inlet and an outlet, wherein said outlet discharges said fluid into said air stream; and
a heating element in thermal contact with said fluid conduit such that said heating element delivers sufficient thermal energy to said fluid traversing said fluid conduit such that the vapor pressure of said fluid is greater than the pressure in said air stream so as to cause said fluid to atomize in said air stream thereby producing a mist of sub-micron sized fluid droplets;
a temperature sensor, said temperature sensor in thermal contact with said fluid so as to determine the temperature of said fluid;
a controller, said controller in electrical communication with said temperature sensor and said heating element, said controller capable of adjusting said heating element's delivery of thermal energy to said fluid in response to said temperature of said fluid and said desired volumetric flow rate; and
a compressor in fluid communication with said air stream, said compressor pressurizing said air stream so as to generate a pressurized flow of air; and
a fuel cell in fluid communication with said compressor, said fuel cell receiving a pressurized flow of air from said compressor.

34. The system according to claim 33 wherein said atomizer introduces said mist of sub-micron sized fluid droplets upstream of said compressor.

35. The system according to claim 33 wherein said atomizer introduces said mist of sub-micron sized fluid droplets within said compressor.

36. A system for producing a mist of sub-micron sized fluid droplets, said system comprising:
an atomizer, said atomizer comprising:
a fluid conduit for transporting a pressurized supply of a fluid, said fluid conduit having an inlet and an outlet, wherein said outlet discharges said fluid into a discharge zone, said fluid conduit additionally comprising at least two electrical contacts for applying a current across said fluid conduit so as to resistively heat said fluid conduit such that the vapor pressure of said fluid is greater than the pressure in said discharge zone so as to cause said fluid to atomize in said discharge zone thereby producing a mist of sub-micron sized fluid droplets;
a temperature sensor, said temperature sensor in thermal contact with said fluid so as to determine the temperature of said fluid;
a flow control element in fluid communication with said atomizer, said flow control element controlling the volumetric flow rate of said fluid; and
a controller, said controller in electrical communication with said temperature sensor, said flow control element, and said heating element, said controller capable of adjusting said heating element's delivery of thermal energy to said fluid in response to said temperature of said fluid and said volumetric flow rate of said fluid, said controller capable of causing said flow control element to adjust said volumetric flow rate of said fluid.
